(19) United States
(12) Patent Application Publication
(10) Pub. No.: US 2024/0126585 A1
(43) Pub. Date: Apr. 18, 2024

(54) PARA-VIRTUALIZED DRIVERS FOR PLATFORM AND CLOUD COMPUTE MANAGEMENT

(71) Applicant: DELL PRODUCTS L.P., Round Rock, TX (US)

(72) Inventors: Ankit Singh, Bangalore (IN); Sumanth Vidyadhara, Bangalore (IN); Shrikant Hallur, Bangalore (IN)

(21) Appl. No.: 17/966,675

(22) Filed: Oct. 14, 2022

(51) Int. Cl. G06F 9/455; G06F 9/4401

(52) U.S. Cl. CPC G06F 9/45558; G06F 9/4403; G06F 2009/45562

(57) ABSTRACT

An information handling system includes a basic input/output system (BIOS), and multiple virtual machines including first and second virtual machines. The first virtual machine communicates with the BIOS and other hardware components within the information handling system. The second virtual machine is configured in a BIOS update configuration. The first virtual machine receives a hypercall from the second virtual machine. The hypercall includes a command having a command type. The first virtual machine determines whether the command type within the hypercall matches a cloud policy assigned to the second virtual machine. In response to the command type matching the cloud policy, the first virtual machine provides the command to a proper hardware component within the information handling system.

### FIELD OF THE DISCLOSURE

The present disclosure generally relates to information handling systems, and more particularly relates to para-virtualized drivers for platform and cloud compute management.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs, and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes a first virtual machine that may communicate with a BIOS and other hardware components within the information handling system. A second virtual machine may be configured in a BIOS update configuration. The first virtual machine may receive a hypercall from the second virtual machine. The hypercall includes a command having a command type. The first virtual machine may determine whether the command type within the hypercall matches a cloud policy assigned to the second virtual machine. In response to the command type matching the cloud policy, the first virtual machine may provide the command to a proper hardware component within the information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a diagram of a portion of an information handling system according to at least one embodiment of the present disclosure;

FIG. 2 is a sequence diagram of a method for transferring data among components of an information handling system according to at least one embodiment of the present disclosure;

FIG. 3 is a flow diagram of a method for virtual machine compute management in an information handling system according to at least one embodiment of the present disclosure; and

FIG. 4 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

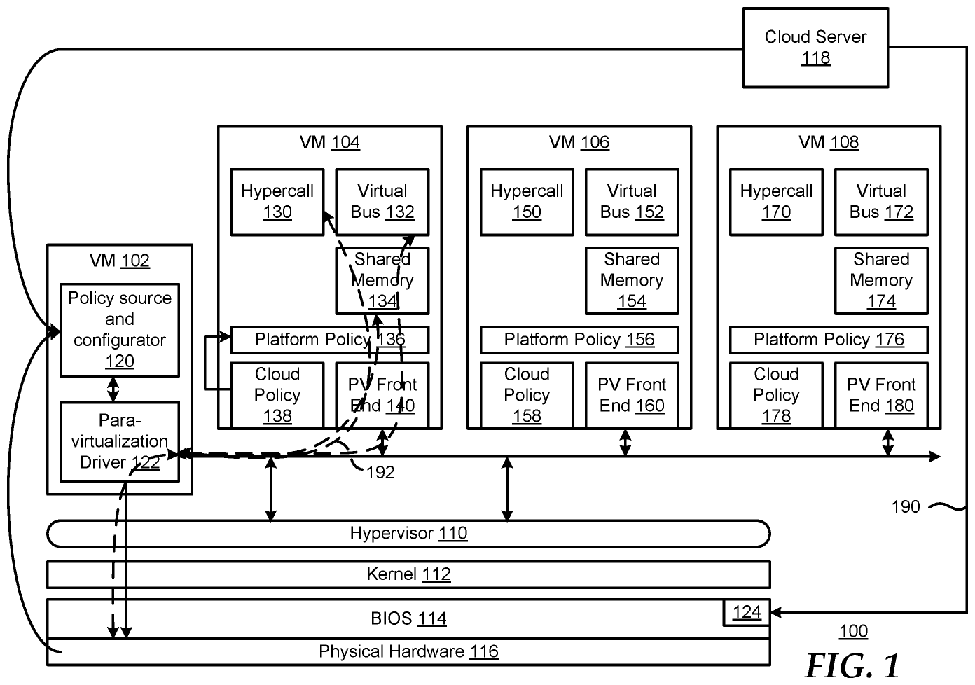

FIG. 1 illustrates a portion of an information handling system 100 according to an embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 100 includes virtual machines (VMs) 102, 104, 106, and 108, a hypervisor 110, a kernel 112, basic input/output system (BIOS) 114, and physical hardware components 116. Information handling system 100 may communicate with a cloud server 118. VM 102 includes a policy source and configurator 120 and a para-virtualization driver 122. VM 104 includes a hypercall module 130, a virtual bus 132, a shared memory 134, a platform policy module 136, a cloud policy module 138, and a front end component 140. VM 106 includes a hypercall module 150, a virtual bus 152, a shared memory 154, a platform policy module 156, a cloud policy module 158, and a front end component 160. VM 108 includes a hypercall module 170, a virtual bus 172, a shared memory 174, a platform policy module 176, a cloud policy module 178, and a front end component 180. Information handling system 100 may include additional components without varying from the scope of this disclosure.

In certain examples, VMs 102, 104, 106, and 108 may be configured as any suitable device to be utilized by information handling system 100. For example, VMs 102, 104, 106, and 108 may configured as a communication server, a BIOS configuration server, a security changes server, a peripheral management server, or the like. In certain examples, VMs 102, 104, 106, and 108 may communicate with cloud server 118 to: initiate downloads, patches, configurations, and other content to information handling system 100 in real-time; initiate actions and performs continuous self-assessment and policy enforcement; enable OS fine tuning; manage devices connected to the peripherals of the information handling system; and dynamically provide visibility to every endpoint. Information handling system 100 may be improved by VM 102 being configured and operated as a domain zero VM within the information handling system. Information handling system 100 may be further improved by hypervisor 110 and kernel 112 performing platform and OS management for the information handling system.

In an example, hypervisor 110 and kernel 112 may operate while information handling system 100 is in a bare metal state as will be described herein. In certain examples, hypervisor 110 and kernel 112 may be secure components of information handling system 100 based on their operation being performed in the bare metal state of the information handling system. While information handling system 100 is the bare metal state, cloud server 118 may provide a configuration signal 190 to BIOS 114 via any suitable communication band, such as an out-of-band communication signal. In an example, configuration signal 190 may be a kernel binary download to begin execution of kernel 112 via BIOS 114. In certain examples, configuration signal 190 may be received and processed by a BIOS connect module 124 within BIOS 114.

Based on configuration signal 190, BIOS connect module 124 of BIOS 114 may launch VM 102 via kernel 112 and hypervisor 110. In an example, VM 102 may be launched as a domain zero or main VM for information handling system 100. VM 102 may have policy source and configurator module 120 and para-virtualization driver 122 built-in and pre-loaded. In response to VM 102 being launched, policy source and configurator module 120 may retrieve or otherwise receive platform and cloud policies for VMs 104, 106, and 108 of information handling system. In certain examples, VM 102 may receive the cloud policies from cloud server 118 and the platform policies from BIOS 114 of information handling system 100. In an example, the cloud policies may be any suitable different policies including, but not limited to, a BIOS configuration policy, a security changes policy, and a peripheral management policy. In certain examples, these policies may be associated with different components of information handling system 100, such, as BIOS, software components, and hardware components.

In response to the platform and cloud policies being received by policy source and configurator module 120, para-virtualization driver 122 may send different policies to each of VMs 104, 106, and 108 via respective front end components 140, 160, and 180. For example, para-virtualization driver 122 may send the BIOS configuration policy to VM 104 via communication signal 192. Para-virtualization driver 122 may send the security changes policy to VM 106 and the peripheral management policy 108 to VM 108. Each VM 104, 106, and 108 may store the received policies in respective shared memories 134, 154, and 174. For example, VM 104 may store platform policy 136 and cloud policy 138, VM 106 may store platform policy 156 and cloud policy 158, and VM 108 may store platform policy 176 and cloud policy 178. Each of VMs 104, 106, and 108 may be launched based on the different configurations received from para-virtualization driver 122 of VM 102.

In an example, after VMs 104, 106, and 108 have been configured and launched according to respective platform policies 136, 156, and 176 and respective cloud policies 138, 158, and 178, the VMs may be utilized to provide different updates to information handling system 100. In previous information handling systems, VMs for an information handling system may provide attack vectors for against the information handling system. In these previous information handling systems, an individual may maliciously access a VM configured to provide peripheral management and utilize this VM to make malicious BIOS configuration changes within the information handling system. Information handling system 100 may be improved by VM 102 verifying that updates or changes for the information handling system are received from the VM, such as VM 104, 106, or 108, configured as the update or management VM for that particular policy.

In certain examples, VM 104 may be configured as the BIOS configuration VM, such that this VM may only provide BIOS attribute changes to information handling system 100. In an example, VM 104 may provide hypercall 130 for a BIOS attribute change to BIOS 114 of information handling system 100. However, VMs 104, 106, and 108 may not be able to communicate directly with hardware components of information handling system, such as BIOS 114. Instead, all communications, such as hypercalls 130, 150, and 170, may be routed from VMs 104, 106, and 108 through VM 102, and then to the proper hardware component, such as BIOS 114 or physical hardware device 116.

In an example, VM 104 may provide a BIOS attribute change command via hypercall 130 over virtual bus 132. In an example, para-virtualization driver 122 may receive hypercall 130 from VM 104. In response to the reception of hypercall 130, para-virtualization device 122 may identify a policy associated the hypercall. For example, if hypercall 130 is a BIOS attribute change command, para-virutalization driver 122 may identify a hypercall command type as being associated with the BIOS configuration policy. Para-virtualization driver 122 may provide the hypercall command type and an identifier for the VM that provided hypercall 130 to policy source and configurator module 120.

Based on the identifier for VM 104, policy source and configurator module 120 may determine the configuration of VM 104. For example, policy source and configurator module 120 may determine that VM 104 is configured as the BIOS configuration VM. Policy source and configurator module 120 may make this determination in any suitable manner including, but not limited to, comparing the identifier of VM 104 to entries in a configuration table. After determining the configuration of VM 104, policy source and configurator module 120 may compare the configuration of VM 104 to the hypercall command type of hypercall 130 received from VM 104.

In response to a determination that the hypercall command type, such as a BIOS attribute change, matching a configuration of the VM, such as VM 104 being configured as the BIOS configuration VM, policy source and configurator module 120 may allow the command from the VM. For example, VM 102 may provide the BIOS attribute change received from VM 104 to BIOS 114. However, if the hypercall command type does not match a configuration of VM that provided the hypercall, policy source and configurator module 120 may prevent the hypercall from being sent to a hardware component of information handling system 100. While the description of hypercalls has been described with respect to VM 104, one of ordinary skill in the art will receognize that these operations may be similarly performed with respect to hypercall 150 from VM 106 and hypercall 170 from VM 108 without varying from the scope of this disclosure.

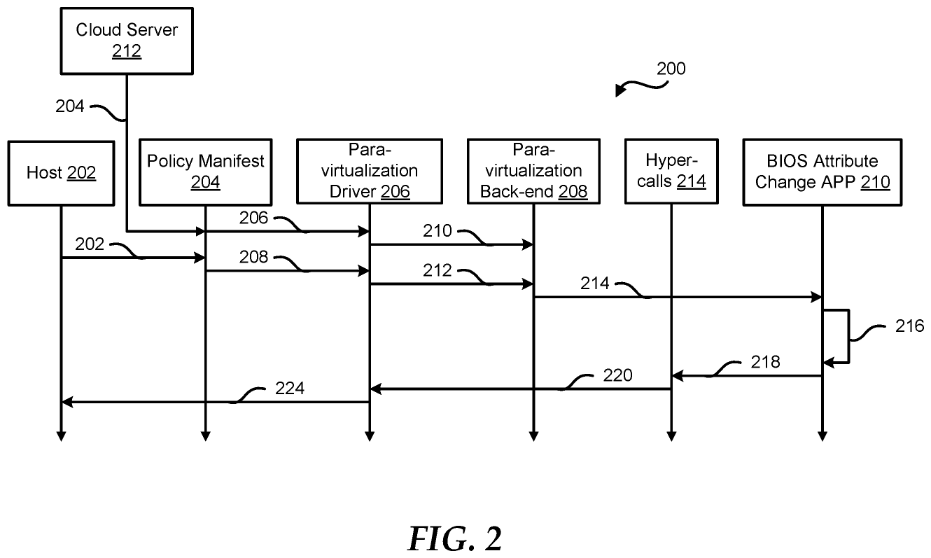

FIG. 2 is a sequence diagram 200 of a method for transferring data among components of an information handling system according to at least one embodiment of the present disclosure. In an example, the components of the information handling system include, but are not limited to, a host 202, a policy manifest module 204, a para-virtualization driver 206, a para-virtualization back-end 208, and a BIOS attribute change application 210. The components the information handling system may communicate with a cloud server 212. Not every step set forth in this sequence diagram is always necessary, and that certain steps of the methods may be combined, performed simultaneously, in a different order, or perhaps omitted, without varying from the scope of the disclosure.

At operation 220, cloud server 212 may provide multiple cloud policies to policy manifest module 204. In an example, the cloud policies may include, but are not limited to, a BIOS policy, a software policy, and a hardware policy. In certain examples, policy manifest module 204 may be located within policy source and configurator 120 of FIG. 1. At operation 222, host 202 may provide a platform policy to policy manifest module 204. At operation 224, policy manifest module 204 may provide one of the cloud policies to para-virtualization driver 206. In an example, the cloud policy may be the BIOS policy. At operation 226, policy manifest module 204 may provide the platform policy to para-virtualization driver 206.

At operation 228, para-virtualization driver 206 provides the cloud policy to the para-virtualization back-end 208. At operation 230, para-virtualization driver 206 provides the platform policy to the para-virtualization back-end 208. At operation 232, the platform policy and the cloud policy are loaded into a VM. Based on the platform policy and the cloud policy, the VM may be configured as a BIOS configuration VM with BIOS attribute change application 210 included within the VM.

At operation 234, BIOS attribute change application 210 may receive a BIOS attribute change for host 202. Based on the BIOS attribute change, a BIOS attribute change command is generated at operation 236. At operation 238, a hypercall 214 may be provided to para-virtualization driver 206. In an example, hypercall 214 may include the BIOS attribute change for host 202. Based on hypercall 214, para-virtualization driver 206 may utilize the cloud policy for the VM associated with BIOS attribute change application 210 and the command within the hypercall. In response to the cloud policy matching the command, para-virtualization driver 206 provides the BIOS attribute change command to host 202 at operation 224.

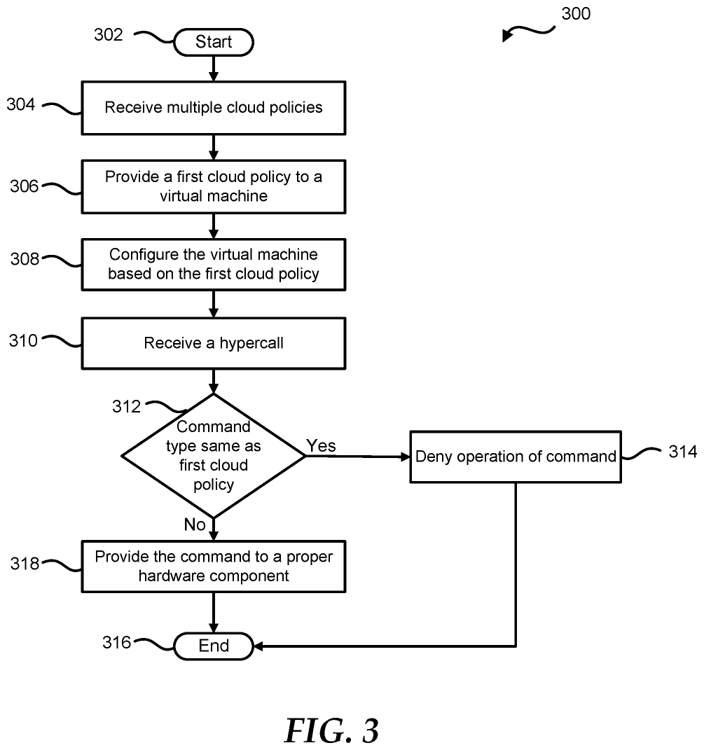

FIG. 3 shows a method 300 for providing virtual machine compute management in an information handling system according to at least one embodiment of the present disclosure, starting at block 302. In an example, the method 300 may be performed by any suitable component including, but not limited to, VMs 102, 104, 106, and 108, hypervisor 110, kernel 112, BIOS 114 and other hardware components 116 of FIG. 1. Not every method step set forth in this flow diagram is always necessary, and certain steps of the methods may be combined, performed simultaneously, in a different order, or perhaps omitted, without varying from the scope of the disclosure.

At block 304, multiple cloud policies are received. In an example, the cloud policies may be received by a first virtual machine of an information handling system, and the cloud policies may be received from a cloud server in communication with the information handling system. The cloud policies may include, but are not limited to, BIOS policies, hardware policies, and software policies.

At block 306, a first cloud policy is provided to a second virtual machine of the information handling system. In an example, the first virtual machine may utilize a para-virtualization driver to provide the first cloud policy to the second virtual machine. At block 308, the second virtual machine is configured based on the first cloud policy.

At block 310, a hypercall is received from the second virtual machine. In an example, the hypercall includes a command having a command type. In certain examples, the command may be any suitable command for a hardware component in the information handling system, such as a BIOS attribute change for the BIOS of the information handling system.

At block 312, a determination is made whether the command type of the command within the hypercall matches the first cloud policy for the second virtual machine. If the command type of the command within the hypercall does not match the first cloud policy, an operation of the command is denied at block 314, and the flow ends at block 316. In response to the command type matching the cloud policy, the command is provided to a proper hardware component within the information handling system at block 318 and the flow ends at block 320.

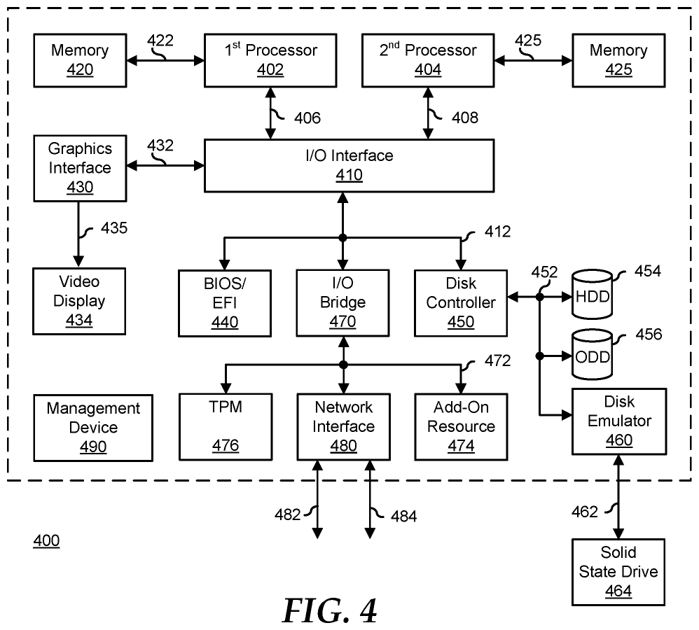

FIG. 4 shows a generalized embodiment of an information handling system 400 according to an embodiment of the present disclosure. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described below and operates to perform one or more of the methods described below. Information handling system 400 includes a processors 402 and 404, an input/output (I/O) interface 410, memories 420 and 425, a graphics interface 430, a basic input and output system/universal extensible firmware interface (BIOS/UEFI) module 440, a disk controller 450, a hard disk drive (HDD) 454, an optical disk drive (ODD) 456, a disk emulator 460 connected to an external solid state drive (SSD) 462, an I/O bridge 470, one or more add-on resources 474, a trusted platform module (TPM) 476, a network interface 480, a management device 490, and a power supply 495. Processors 402 and 404, I/O interface 410, memory 420, graphics interface 430, BIOS/UEFI module 440, disk controller 450, HDD 454, ODD 456, disk emulator 460, SSD 462, I/O bridge 470, add-on resources 474, TPM 476, and network interface 480 operate together to provide a host environment of information handling system 400 that operates to provide the data processing functionality of the information handling system. The host environment operates to execute machine-executable code, including platform BIOS/UEFI code, device firmware, operating system code, applications, programs, and the like, to perform the data processing tasks associated with information handling system 400.

In the host environment, processor 402 is connected to I/O interface 410 via processor interface 406, and processor 404 is connected to the I/O interface via processor interface 408. Memory 420 is connected to processor 402 via a memory interface 422. Memory 425 is connected to processor 404 via a memory interface 427. Graphics interface 430 is connected to I/O interface 410 via a graphics interface 432 and provides a video display output 436 to a video display 434. In a particular embodiment, information handling system 400 includes separate memories that are dedicated to each of processors 402 and 404 via separate memory interfaces. An example of memories 420 and 430 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 440, disk controller 450, and I/O bridge 470 are connected to I/O interface 410 via an I/O channel 412. An example of I/O channel 412 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 410 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 440 includes BIOS/UEFI code operable to detect resources within information handling system 400, to provide drivers for the resources, initialize the resources, and access the resources. BIOS/UEFI module 440 includes code that operates to detect resources within information handling system 400, to provide drivers for the resources, to initialize the resources, and to access the resources.

Disk controller 450 includes a disk interface 452 that connects the disk controller to HDD 454, to ODD 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an IEEE 4394 (Firewire) interface, a proprietary interface, or a combination thereof. Alternatively, solid-state drive 464 can be disposed within information handling system 400.

I/O bridge 470 includes a peripheral interface 472 that connects the I/O bridge to add-on resource 474, to TPM 476, and to network interface 480. Peripheral interface 472 can be the same type of interface as I/O channel 412 or can be a different type of interface. As such, I/O bridge 470 extends the capacity of I/O channel 412 when peripheral interface 472 and the I/O channel are of the same type, and the I/O bridge translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as I/O interface 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management device 490 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 400. In particular, management device 490 is connected to various components of the host environment via various internal communication interfaces, such as a Low Pin Count (LPC) interface, an Inter-Integrated-Circuit (I2C) interface, a PCIe interface, or the like, to provide an out-of-band (00B) mechanism to retrieve information related to the operation of the host environment, to provide BIOS/UEFI or system firmware updates, to manage non-processing components of information handling system 400, such as system cooling fans and power supplies. Management device 490 can include a network connection to an external management system, and the management device can communicate with the management system to report status information for information handling system 400, to receive BIOS/UEFI or system firmware updates, or to perform other task for managing and controlling the operation of information handling system 400.

Management device 490 can operate off of a separate power plane from the components of the host environment so that the management device receives power to manage information handling system 400 when the information handling system is otherwise shut down. An example of management device 490 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 490 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system comprising:
a basic input/output system (BIOS); and
a first virtual machine configured to communicate with the BIOS and other hardware components within the information handling system, and a second virtual machine configured based on a cloud policy, wherein the first virtual machine to:
receive a hypercall from the second virtual machine, wherein the hypercall includes a command having a command type;
determine whether the command type within the hypercall matches the cloud policy for the second virtual machine; and
in response to the command type matching the cloud policy, provide the command to a proper hardware component within the information handling system.

2. The information handling system of claim 1, wherein the first virtual machine further to receive the cloud policy from a cloud server.

3. The information handling system of claim 1, wherein in response to the command type not matching the cloud policy, the first virtual machine to deny an operation of the command, wherein the denying of the operation includes preventing the command from being provided to the proper hardware component.

4. The information handling system of claim 1, wherein the BIOS is configured to receive a configuration signal while the information handling system is in a bare metal state.

5. The information handling system of claim 4, wherein the BIOS further to launch the first virtual machine in response to the configuration signal.

6. The information handling system of claim 4, wherein the configuration signal is an out-of-band communication signal.

7. The information handling system of claim 4, wherein in response to the configuration signal the BIOS to begin execution of a kernel in the information handling system.

8. The information handling system of claim 1, further comprising: third and fourth virtual machines, wherein the second, third, and further virtual machines are configured differently based on different cloud policies.

9. A method comprising:
receiving, at a first virtual machine of an information handling system, a plurality of cloud policies including first and second cloud policies;
providing, by the first virtual machine, the first cloud policy to a second virtual machine of the information handling system;
configuring the second virtual machine based on the first cloud policy;
receiving, by the first virtual machine, a hypercall from the second virtual machine, wherein the hypercall includes a command having a command type;
determining whether the command type within the hypercall matches the first cloud policy for the second virtual machine; and
in response to the command type matching the cloud policy, providing the command to a proper hardware component within the information handling system.

10. The method of claim 9, further comprising receiving, by the first virtual machine, the cloud policies from a cloud server.

11. The method of claim 9, wherein in response to the command type not matching the cloud policy, the method further comprises denying an operation of the command, wherein the denying of the operation includes preventing the command from being provided to the proper hardware component.

12. The method of claim 9, further comprising receiving, by a basic input/output system (BIOS) of the information handling system, a configuration signal while the information handling system is in a bare metal state.

13. The method of claim 12, further comprising launching, by the BIOS, the first virtual machine in response to the configuration signal.

14. The method of claim 12, wherein the configuration signal is an out-of-band communication signal.

15. The method of claim 12, wherein in response to the configuration signal, beginning execution of a kernel in the information handling system.

16. An information handling system comprising:
a basic input/output system (BIOS) configured to launch a virtual machine in response to reception of a configuration signal; and
a first virtual machine configured to communicate with the BIOS and other hardware components within the information handling system; and
a second virtual machine configured based on a cloud policy;
wherein the first virtual machine is to:
receive a hypercall from the second virtual machine, the hypercall including a command having a command type; and
if the command type matches the cloud policy then provide the command to a proper hardware component within the information handling system, otherwise deny an operation of the command, wherein the denying of the operation includes preventing the command from being provided to the proper hardware component.

17. The information handling system of claim 16, wherein the denying of the operation includes preventing the command from being provided to the proper hardware component.

18. The information handling system of claim 16, wherein the first virtual machine further to receive the cloud policy from a cloud server.

19. The information handling system of claim 16, further comprising: third and fourth virtual machines, wherein the second, third, and further virtual machines are configured differently based on different cloud policies.

20. The information handling system of claim 16, wherein in response to the configuration signal the BIOS to begin execution of a kernel in the information handling system.
